(19) United States
(12) Patent Application Publication
(10) Pub. No.: US 2013/0216988 A1
(43) Pub. Date: Aug. 22, 2013

(54) BRAIN TRAINING SYSTEM USING EXERCISE BICYCLE

(71) Applicants: Heecheon You, Pohang-si (KR); Duk Lyul Na, Seoul (KR); Giltae Yang, Goyang-si (KR); Young-Geun Choi, Seoul (KR)

(72) Inventors: Heecheon You, Pohang-si (KR); Duk Lyul Na, Seoul (KR); Giltae Yang, Goyang-si (KR); Young-Geun Choi, Seoul (KR)

(21) Appl. No.: 13/881,178

(22) PCT Filed: Oct. 27, 2011
(86) PCT No.: PCT/KR2011/008091

§ 371 Date: Apr. 24, 2013

(30) Foreign Application Priority Data
Oct. 27, 2010 (KR) 10-2010-0105026

(51) Int. Cl. G09B 19/00

(52) U.S. Cl. CPC G09B 19/00
USPC 434/236

(57) ABSTRACT

Provided is a brain training system using an exercise bicycle, including: a display device configured to reproduce a moving picture selected by a user and display the moving picture on a screen; a control box configured to control the display device; and a driving device configured to generate a driving information signal while being driven by physical driving power of the user and transfer the driving information signal to the control box, in which the control box controls the reproduction of the moving picture of the display device according to the driving information signal transferred from the driving device.

### TECHNICAL FIELD

The present invention relates to a brain training system, and more particularly, to a brain training system using an exercise bicycle for education of babies and children, family games, or prevention of dementia of aged people.

### BACKGROUND ART

Today, as Korea is becoming an aging society, the population of aged people has rapidly increased and a prevalence rate of dementia has increased, and as a result, the number of demented patients has rapidly increased. In order to solve the problems, a local government has taken a high social interest for dementia problems of the aged, by expanding medical treatment facilities and health care facilities, and the like. It is important to treat and prevent the dementia, and recently, the interest in a field for preventing the dementia has increased.

As one measure for preventing the dementia, a brain fitness program has been developed to provide a training method required to maintain and improve high-level functions of a brain.

### DISCLOSURE

### Technical Problem

The present invention has been made in an effort to provide a brain training system using an exercise bicycle having advantages of allowing a user to experience a virtual travel together with a physical exercise by controlling a moving picture screen of a travel destination reproduced on a display device when the user drives a driving device such as an exercise bicycle and of supporting the user to improve social, emotional, physical, and cognitive abilities by allowing the user to answer a quiz regarding travel information acquired from the travel destination after traveling.

The present invention has been made in an effort to provide a brain training system using an exercise bicycle having advantages of allowing a user to race with many different users with a road image directly selected by the user as a background on the display device while driving the exercise bicycle and to answer many quizzes as possible for a predetermined time.

### Technical Solution

An exemplary embodiment of the present invention provides a brain training system through a virtual traveling, including: a display device configured to reproduce a moving picture of a travel destination and display the moving picture on a screen; a control box configured to control the display device; and a driving device configured to generate a driving information signal while being driven by physical driving power of the user and transfer the driving information signal to the control box, in which the control box controls the reproduction of the moving picture of the display device according to the driving information signal transferred from the driving device

The driving device may include a pedal driving unit and a wheel unit, and the pedal driving unit may be driven by physical driving power of the user to rotate the wheel unit.

The wheel unit may have a magnetic body, and a speed sensor adjacent to the magnetic body may be installed on the wheel unit, and the speed sensor may sense movement of the magnetic body to generate the driving information signal and transfer the driving information signal to the control box.

When the wheel unit rotates one cycle, eight frames of the moving picture of the travel destination may be sequentially reproduced on the display device.

The driving device may further include a steering unit including a left handle and a right handle, and each of the left handle and the right handle may include a selection button configured to select selection information displayed on the display device through the control box.

The control box may be configured to output a quiz regarding the travel destination information on the display device, and select an answer of the output quiz by selecting the button of the left handle or the right handle of the steering unit.

The driving device may further include a steering unit including a left handle and a right handle, and configured to display left and right hidden images of the reproduced moving picture by laterally rotating the steering unit.

The steering unit may include a potentionmeter to transfer a steering signal to the control box.

The steering unit may be configured to be attachable to and detachable from separately the pedal driving unit and the wheel unit of the driving device, and the separated steering unit may be installed and used on an existing general bicycle or a bicycle for health.

The control box may include a database, and moving pictures of the travel destination to be reproduced or a travel destination map, quizzes, and the like are stored in the database, and still images or moving pictures which are directly photographed by the user may be stored and used in the database.

Further, the control box may be configured to play a relay game with many users as a team.

### Advantageous Effects

In the brain training system using the exercise bicycle according to the exemplary embodiment of the present invention, it is possible to support a user to perform physical, emotional, and social trainings by providing an image of a local area which is not easily gone usually together with a bicycle exercise.

Further, it is possible to improve a cognitive ability of a user by providing information on a travel destination during traveling through the screen and providing a quiz after the traveling ends for the user to select an answer.

In the brain training system using the exercise bicycle according to another exemplary embodiment of the present invention, it is possible to enable a user to recall a memory by providing an image directly photographed by the user together with a bicycle exercise and support the user to perform emotional, social, and physical trainings by racing with different users as a team.

Further, it is possible to improve physical ability and cognitive ability of the user by providing a simple quiz while reproducing the moving picture and allowing the user to select an answer while racing.

### DESCRIPTION OF DRAWINGS

FIG. 1 is a configuration diagram schematically illustrating a configuration of a brain training system according to an exemplary embodiment of the present invention.

FIG. 2 is a block diagram schematically illustrating the configuration of the brain training system according to the exemplary embodiment of the present invention.

FIG. 3 is a perspective view illustrating a steering unit of a driving device configuring the brain training system according to the exemplary embodiment of the present invention.

FIG. 4 is an image exemplarily illustrating a screen of a display device of the brain training system according to the exemplary embodiment of the present invention.

FIG. 5 is a flowchart illustrating a process in which a program progresses through the brain training system according to the exemplary embodiment of the present invention.

FIG. 6 is a flowchart illustrating a process in which a program progresses through a brain training system according to another exemplary embodiment of the present invention.

FIG. 7 is an image exemplarily illustrating a screen of a display device of the brain training system according to another exemplary embodiment of the present invention.

### MODE FOR INVENTION

The present invention will be described more fully hereinafter with reference to the accompanying drawings, in which exemplary embodiments of the invention are shown. As those skilled in the art would realize, the described embodiments may be modified in various different ways, all without departing from the spirit or scope of the present invention. The drawings and description are to be regarded as illustrative in nature and not restrictive. Like reference numerals designate like elements throughout the specification.

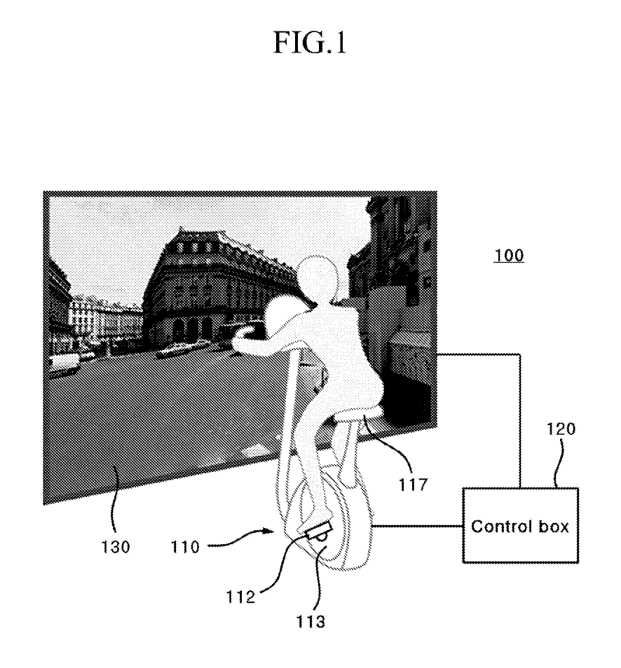

FIG. 1 is a configuration diagram schematically illustrating a configuration of a brain training system according to an exemplary embodiment of the present invention.

A brain training system 100 (hereinafter, abbreviated as a “system”) according to the exemplary embodiment includes a display device 130 and a control box 120 controlling the display device, and further includes a driving device 110 driven by physical driving power of a user.

The display device 130 reproduces moving pictures of travel destinations and displays the moving pictures on a screen, and may display a menu so that the user may input desired information such that the user selects a desired travel destination. The control box 120 is connected with the display device 130 either wired or wirelessly so as to transmit and receive signals and controls the screen of the display device 130 according to input information. The driving device 110 is driven by physical driving power of the user to generate a driving information signal and transfer the driving information signal to the control box 120. The control box 120 controls the moving picture reproduction of the display device 130 according to the transferred driving information signal.

The driving device 110 includes a pedal driving unit 112 and a wheel unit 113, and the pedal driving unit 112 is driven by physical driving power of the user so that the wheel unit rotates. Further, the driving device 110 includes a steering unit 115 which may be used for selection of a direction or selection of information. For example, the driving device 110 has a structure similar to a bicycle, such that a seat 117 is positioned above the wheel unit 113, and the steering unit 115 is positioned at and fixed to a front of the seat 117. Therefore, the user takes the seat 117, grasps the steering unit 115 by the hand, and turns the pedal driving unit 112 by the foot to rotate the wheel unit 113 connected with the pedal driving unit 112.

In another exemplary embodiment, the control box 120 may be integrally configured with the driving device 110, and further, in another exemplary embodiment, the control box 120 may be integrally configured with the display device 110.

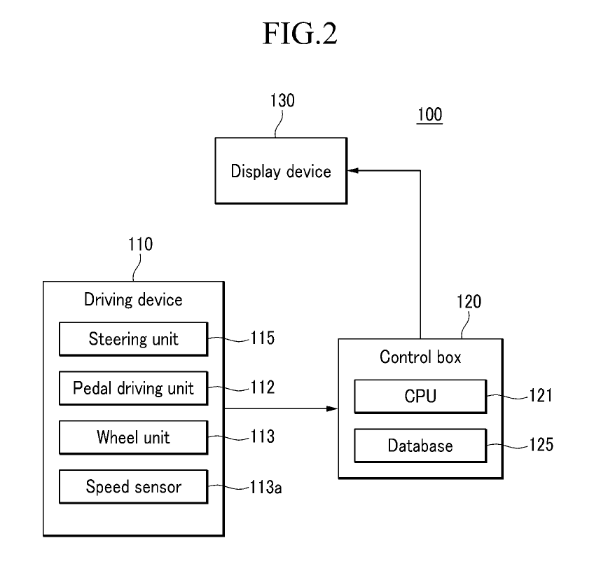

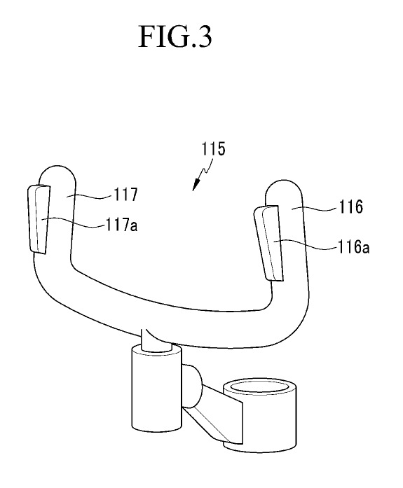

FIG. 2 is a block diagram schematically illustrating the configuration of the brain training system according to the exemplary embodiment of the present invention, and FIG. 3 is a perspective view illustrating a steering unit of a driving device configuring the brain training system according to the exemplary embodiment of the present invention.

Referring to FIG. 2, the driving device 110 of the system 100 according to the exemplary embodiment includes the steering unit 115, the pedal driving unit 112, and the wheel unit 113, as described with reference to FIG. 1.

Referring to FIG. 3, the steering unit 115 includes a right handle 116 and a left handle 117, and a potentionmeter (not illustrated) for steering is installed on the steering unit 115. Further, at least two selection buttons 116a and 117a are included on the right handle 116 and the left handle 117 so as for a user to select items displayed on the display device 130. In addition, in the wheel unit 113, a magnetic body (not illustrated) is provided and a speed sensor 113a is installed to be adjacent to the magnetic body, and the magnetic body transmits a signal to the speed sensor 113a when the wheel unit 113 rotates. For example, in the case where the wheel unit 113 has four magnetic bodies, when the speed sensor senses movement of the magnetic bodies and signals are input and output, image frames are reproduced one by one, and as a result, eight image frames may be sequentially reproduced for one cycle of the wheel unit 113.

The steering unit 115 is configured as a part of the driving device 110 and may be integrally formed with the pedal driving unit 112 and the wheel unit 113, and in another modified example, the steering unit 115 is formed to be selectively attachable and detachable and thus may be used while being installed on an existing general bicycle or a bicycle for health.

Referring back to FIG. 2, the control box 120 includes a central processing unit (CPU) 121 and a database 125, and receives the driving information signal transferred from the driving device 110 to control the screen to be reproduced on the display device 130. That is, the control box 120 performs a selection operation according to a button selected by the steering unit 115 of the driving device 110 in order to select an image to be reproduced, and may control a reproduction speed of the moving picture according to movement information of the pedal driving unit 112 and the wheel unit 113 of the driving device 110 in order to reproduce the moving picture (for example, the moving picture of the travel destination). In addition, the control box 120 may change an area of the screen to be reproduced on the display device 130 according to the rotation of the steering unit 115 in order to change a view.

Meanwhile, in the exemplary embodiment of the present invention, the control box 120 may display a quiz regarding the travel destination information on the display device 130 after virtual traveling ends, and the user may press a selection button provided on the steering unit 115 of the driving device 110 to select an answer from the quiz. The control box 120 includes the database 125 to store software data including the travel destination moving picture, a travel destination map, quizzes regarding the travel destination information, and the like.

Further, in another exemplary embodiment of the present invention, the control box 120 may display the quiz on the display device 130 during the moving picture reproduction, and the user may press the selection button provided on the steering unit 115 of the driving device 110 to select an answer from the quiz. The control box 120 includes the database 125 to store software data including a still image and a moving picture which are directly photographed by the user, and quizzes which are directly prepared by the user, and the like.

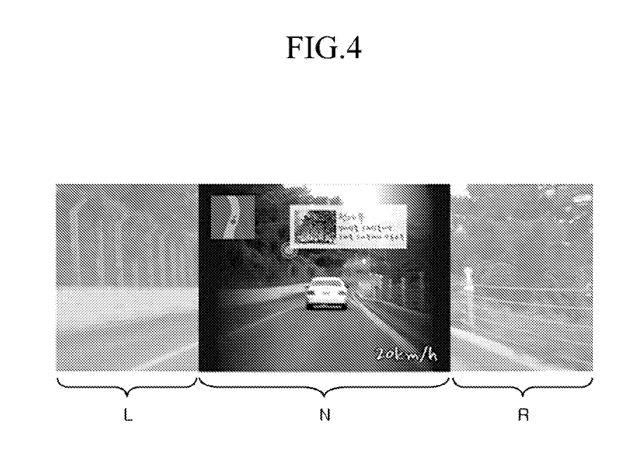

The display device 130 may include a speaker outputting a sound so as for the user to feel auditory satisfaction together with the screen and may be configured to have screen resolution at a ratio of 4:3. As illustrated in FIG. 4, since the image provided to the system 100 of the exemplary embodiment is photographed at screen resolution having a ratio of 16:9, and basically, a screen N at a ratio of 4:3 is reproduced on the display device 130, a left partial screen L and a right partial screen R are not reproduced. However, the left and right portions of the photographed image may be additionally reproduced by rotating the steering unit 115 leftward and rightward. Further, higher reality may be provided by using a 360° virtual reality (VR) image. The screen reproduced on the display device 130 may be used by storing and reading the still image or the moving picture which is directly photographed by the user in the database 125 of the control box 120 and may be used by storing the still image or the moving picture in a portable storing medium (for example, a USB device and the like) and reading the stored still image or moving picture through the control box 120.

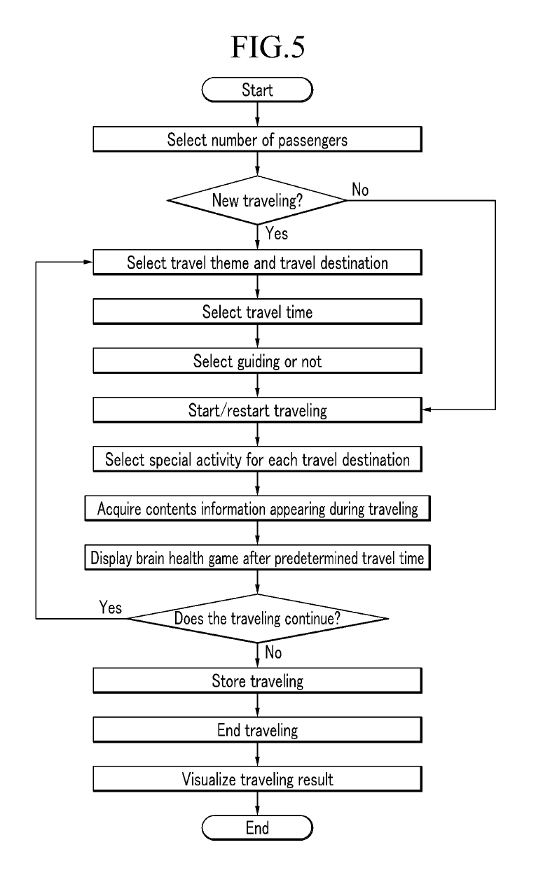

FIG. 5 is a flowchart illustrating a process in which a program progresses through the brain training system according to the exemplary embodiment of the present invention, which is a process of progressing a virtual traveling.

Referring to FIG. 5, first, a power source of the system 100 is turned on and then the number of passengers for traveling is selected. Thereafter, whether new traveling starts or previously started traveling restarts is selected.

In the case of starting the new traveling, a travel theme and a travel destination are selected and a travel time is selected, and then guiding or not is selected.

When the traveling starts and the pedal driving unit 112 of the driving device 110 is driven and the wheel unit 113 rotates, as the speed sensor senses four magnetic bodies provided on the wheel unit 113, and signals are input and output, image frames are reproduced one by one, and as a result, eight image frames may be sequentially reproduced for one cycle of the wheel unit 113.

In the case where a special activity is set for each travel destination, the special activity may be selected and performed while traveling the corresponding travel destination, and the display device 130 may display information regarding the travel destination on the left and right of the screen together with the moving picture of the travel destination while traveling. In this case, screen left information or screen right information may be selected and checked by the selection button provided on the steering unit 115 of the driving device 110.

After the traveling ends for the set travel time, a quiz based on the information acquired in the travel destination is provided on the screen of the display device 130, and the user selects an answer from the quiz by using the selection button of the steering unit 115. That is, as an example, when a two-choice example is displayed together with the quiz on the display device 130, the user may press one of the left and right selection buttons of the steering unit 115 to select an answer.

When the quiz game regarding the travel information ends, whether or not to continue the traveling is determined, and in the case of continuing the traveling, the process returns to the process of selecting a travel theme and a travel destination again, and in the case of ending the traveling, the traveling is stored and ends. The process of storing the traveling may be automatically stored in the system just before the traveling ends. After the traveling ends, the user may easily check the traveling result by visualizing the traveling result.

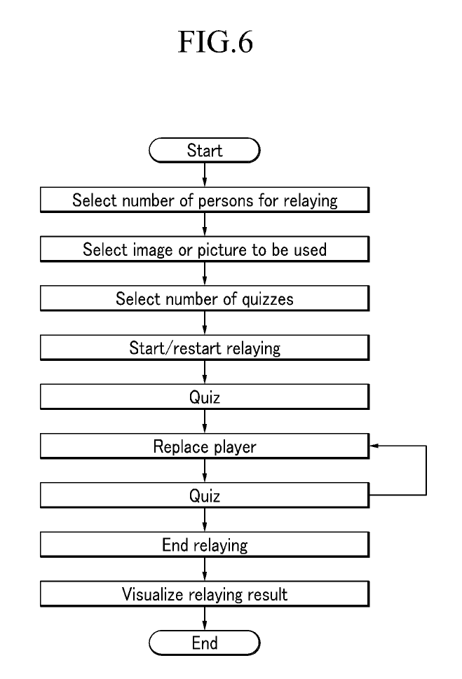

FIG. 6 is a flowchart illustrating a process in which a program progresses through a brain training system according to another exemplary embodiment of the present invention, which is a process of continuing a relay game while answering a quiz.

Referring to FIG. 6, first, a power source of the system 100 is turned on and then the number of persons to join in a relay game is selected. Thereafter, an image to be used as a background and the number of quizzes to be answered are selected.

When a program starts and the pedal driving unit 112 of the driving device 110 is driven and the wheel unit 113 rotates, as the speed sensor senses a magnetic body provided on the wheel unit 113 and signals are input and output, image frames are reproduced one by one, and as a result, image frames are sequentially reproduced according to a rotational speed of the wheel unit 113.

While the moving picture is reproduced, a quiz which is prepared previously by a user or a helper is arbitrarily provided on the screen of the display device 130, and the user selects an answer from the quiz by using a selection button of the steering unit 115. That is, as an example, when a two-choice example is displayed together with the quiz on the display device 130, the user may press one of the left and right selection buttons of the steering unit 115 to select an answer.

When the reproduction of the moving picture ends, a final required time and a correct answer rate of the quiz are calculated and then a total score is provided on the screen of the display device 130.

The control box 120 includes a database, and still images and moving pictures to be reproduced, quizzes, and the like are stored in the database, the still images and moving pictures which are directly photographed by the user, and quizzes which are directly prepared by the user may be stored in the database and used.

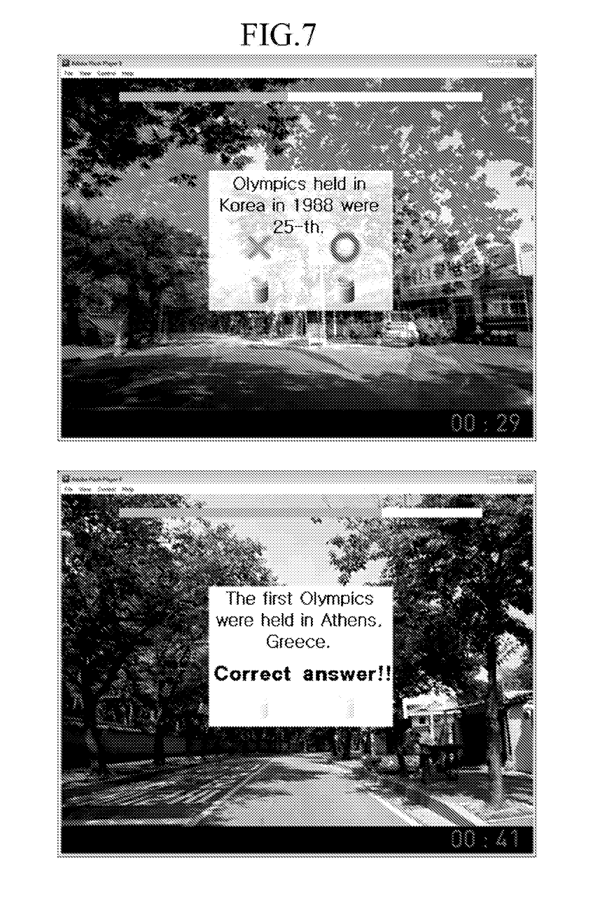

FIG. 7 is an image exemplarily illustrating a screen of a display device of the brain training system according to another exemplary embodiment of the present invention.

As illustrated in FIG. 7, a quiz to be answered by the user is provided at the center of the screen, and an immediate result is provided by an icon and a sound according to a correct answer.

While this invention has been described in connection with what is presently considered to be practical exemplary embodiments, it is to be understood that the invention is not limited to the disclosed embodiments, but, on the contrary, is intended to cover various modifications and equivalent arrangements included within the scope of the appended claims.

1. A brain training system using an exercise bicycle, comprising:
a display device configured to reproduce a moving picture selected by a user and display the moving picture on a screen;
a control box configured to control the display device; and
a driving device configured to generate a driving information signal while being driven by physical driving power of the user and transfer the driving information signal to the control box,
wherein the control box controls the reproduction of the moving picture of the display device according to the driving information signal transferred from the driving device.

2. The brain training system of claim 1, wherein:
the driving device includes a pedal driving unit and a wheel unit, and
the pedal driving unit is driven by physical driving power of the user to rotate the wheel unit.

3. The brain training system of claim 2, wherein:
the wheel unit has a magnetic body, and a speed sensor adjacent to the magnetic body is installed on the wheel unit, and
the speed sensor senses movement of the magnetic body to generate the driving information signal and transfer the driving information signal to the control box.

4. The brain training system of claim 3, wherein:
when the wheel unit rotates, the display device reproduces the moving picture in real time by interlocking with the wheel unit.

5. The brain training system of claim 3, wherein:
when the wheel unit rotates one cycle, eight frames of the moving picture are sequentially reproduced on the display device.

6. The brain training system of claim 1, wherein:
the driving device further includes a steering unit including a left handle and a right handle, and
each of the left handle and the right handle includes a selection button configured to select selection information displayed on the display device through the control box.

7. The brain training system of claim 6, wherein:
the control box outputs a quiz on the display device, and
selects an answer of the output quiz by selecting the button of either the left handle or the right handle of the steering unit.

8. The brain training system of claim 1, wherein:
the driving device further includes a steering unit including a left handle and a right handle, and
is configured to display left and right hidden images of the reproduced moving picture by laterally rotating the steering unit.

9. The brain training system of claim 8, wherein:
the steering unit includes a potentionmeter to transfer a steering signal to the control box.

10. The brain training system of claim 1, wherein:
the control box includes a database.

11. The brain training system of claim 10, wherein:
the database includes an image database, a quiz database, and a score database.

12. The brain training system of claim 10, wherein:
still images or moving pictures which are directly photographed by the user, and quizzes are stored in the database and used.

13. The brain training system of claim 1, wherein:
the control box is configured to play a relay game with many users as a team.
